(19) United States
(12) Patent Application Publication
(10) Pub. No.: US 2025/0326676 A1
(43) Pub. Date: Oct. 23, 2025

(54) GLASS TEMPERING PROCESS, IN PARTICULAR FOR LOW-EMISSION GLASSES

(71) Applicant: Mazzaroppi Engineering S.R.L., Roma (RM) (IT)

(72) Inventor: Antonio MAZZAROPPI, Roma (RM) (IT)

(21) Appl. No.: 19/070,286

(22) Filed: Mar. 4, 2025

(30) Foreign Application Priority Data
Mar. 15, 2024 (IT) 102024000005794

(51) Int. Cl. C03B 27/04

(52) U.S. Cl. CPC C03B 27/0417; C03B 27/0404

(57) ABSTRACT

A method for tempering glass panes involves acquiring an image of a glass pane conveyed on conveyor rollers, acquiring a distribution map of heat absorption coefficient in the glass pane, recognizing, by an electronic processing unit, geometric shape and overall dimensions of the glass pane based on the acquired image, and a position of one or more parts with respective heat absorption coefficient within the geometric shape, conveying the glass pane into a furnace provided with resistances and nozzles, determining, by an electronic processing unit, an instantaneous position of the glass pane and of the one or more parts with respective heat absorption coefficient inside the furnace, and individually activating the resistances and the nozzles as a function of their proximity to the one or more parts with respective heat absorption coefficient, in inversely proportional manner to the respective heat absorption coefficient. A furnace is configured to perform the method.

### CROSS-REFERENCE TO RELATED APPLICATIONS

This application claims the priority benefit of Italian Patent Application No. 102024000005794 to Mazzaroppi, filed on Mar. 15, 2024.

### INTRODUCTION

The present invention relates to a method for tempering glass panes, in particular low-emissivity glass panes.

### BACKGROUND ART

Both regular glass panes and low-emissivity glass panes have generic shapes and screen-printed zones. The latter, being black, better absorbs the heat provided with respect to the zones not screen-printed, thereby causing a non-homogeneous heating of the glass sheet and accordingly, a deformation of the same and non-optimal qualities.

EP 0 937 687 describes a method and apparatus for localizing or focusing heating in a tempering furnace for glass panels. The glass panels are transported and supported in a furnace by rollers. The furnace is equipped with upper and lower nozzles for blowing hot convection air to heat the glass panels to a tempering temperature. The arrival of a load in the furnace is preceded by reading an image of the load, and the radiative heating elements present in the furnace are controlled in such a way that the radiative heating can be focused on the central areas of the glass panels to provide them with supplementary heating.

U.S. Pat. No. 11,851,360 relates to a method for controlling a furnace for heating glass sheets using information describing a glass load comprising a plurality of glass sheets. The method comprises transporting the glass sheets towards a heating furnace, prior to heat treatment, photographing the glass load with a camera to obtain a camera image, sending the first camera image information to a computer, based on which the computer determines a first value of a dimension of the glass load. Furthermore, the dimensions are further determined by scanning a line scanner, the result of which is formulated as a second dimensional value. The computer then adjusts one or more furnace parameters before the glass enters the furnace, using the first and second values.

Therefore, the need remains to provide a method and an apparatus for homogeneously heating glass panes having screen-printed zones or generally zones with different heat absorption.

### PURPOSE AND OBJECT OF THE INVENTION

It is the object of the present invention to provide a method and an apparatus which solve the problems and overcome the drawbacks of the prior art.

The present invention relates to a method and an apparatus according to the appended claims.

### DETAILED DESCRIPTION OF EXAMPLES OF EMBODIMENTS OF THE INVENTION

### List of Figures

The present invention will now be described by way of a non-limiting illustration, with particular reference to the figures in the accompanying drawings, in which:

FIG. 1 shows, in (a), a side sectional view of the inside of a tempering furnace with conveyor rollers and a glass pane conveyed thereby and subjected to video detection; in (b), the same apparatus in plan; and in (c), the glass pane alone on the rollers; and

FIG. 2 shows in (a) a side sectional view of a tempering furnace; in (b), the same apparatus in plan; in (b1), a detail of the edge zone of the glass pane in the tempering furnace; and in (b2) a further detail of a different edge of the glass pane in the tempering furnace.

It is here specified that elements of different embodiments can be combined to provide further embodiments, without restrictions, by respecting the technical concept of the invention, as those skilled in the art will effortlessly understand from the description.

The present description also makes reference to the prior art for the implementation thereof in relation to the detail features not described, such as elements of minor importance usually used in the prior art in solutions of the same type.

When an element is introduced, it is always understood that there can be “at least one” or “one or more”.

When a list of elements or features is given in this description, it is understood that the finding according to the present invention “comprises” or alternatively “consists of” such elements.

When listing features within the same sentence or bullet list, one or more of the individual features can be included in the invention without connection to the other features on the list.

Two or more of the parts (elements, devices, systems) described below can be freely associated and considered as part kits according to the invention.

### Embodiments

To overcome the problem of non-uniform heating in a furnace of glass exhibiting areas with different heat absorption coefficients, the present invention aims to supply heat in a differentiated manner to the various areas of the glass, particularly based on their proximity to heating elements and/or nozzles of the furnace in said areas, and inversely proportional to their respective heat absorption coefficient.

Such zones can be provided with more or less heat, both by radiation and forced convection.

Preferably, this is implemented by individually turning OFF or ON the heat sources in the furnace. However, it is also possible to activate them partially (to a heating value predetermined each time), should such sources allow it.

Preferably, the individual heat sources are more concentrated than in conventional tempering furnaces so as to better follow the outlines of the glass pane.

These activations are managed by an electronic unit which monitors the passage of the glass pane in the furnace on classic conveyor rollers.

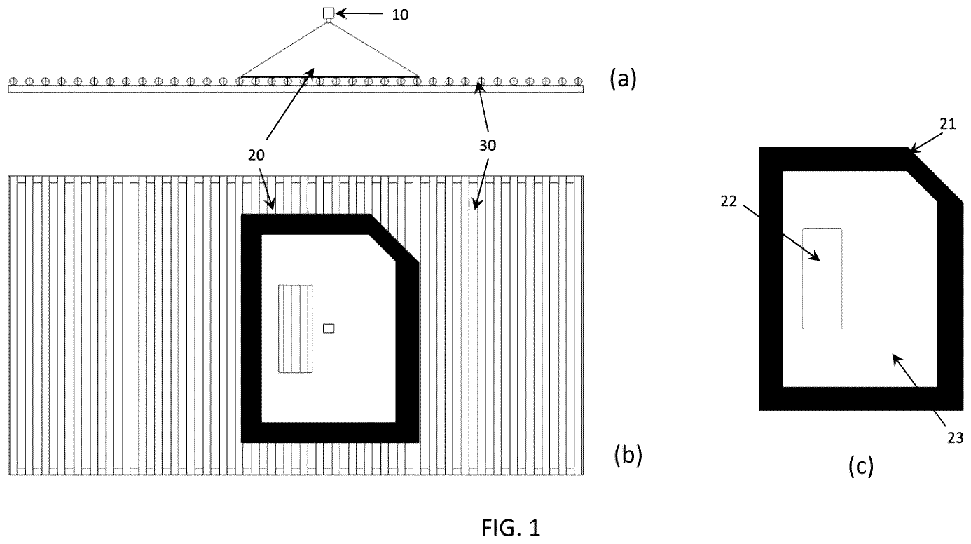

Referring to FIGS. 1 (a) and (b), the glass pane 20 moves on the conveyor rollers 30 and stops before entering the furnace (and therefore, prior to the heating) to be visually acquired by a camera or vision system 10. Thereby, the apparatus according to the present invention can be adapted to any shape and dimensions of the glass pane to be tempered (as well as the presence of any windows in the sheet and any other differentiating geometric element in terms of heat absorption). The processing unit recognizes shapes and dimensions in the acquired image.

Again, there is acquired, before entering the furnace, a distribution map of heat absorption coefficient in the glass pane conveyed on conveyor rollers. Based on such a map, there are determined the dimensions, shape and position of zones (or “parts”) with a different (respective) absorption coefficient within the already determined geometric shape of the glass pane, dimension and position of screen-printed zones, for example.

In both cases, recognition can be performed using artificial intelligence

The shape and overall dimension acquisition system and the absorption coefficient map acquisition system can be the same system or different systems. Preferably, such systems are different and the absorption coefficient map acquisition system is not used to determine the geometry and the overall dimensions of the glass pane.

Within the scope of the invention, the previous acquisitions can be made through the described acquisition systems, with specific sensors, or digital images of the geometry and dimensions on one hand, and of the areas with different absorption coefficients on the other hand, can be acquired, if available as ready-to-use digital images for the particular glass about to enter the furnace (or if the data is entered directly by the operator). In such a case, the determination of the geometric shape, overall different absorption dimensions, and areas with coefficients can already be included in the digital images, and therefore the phase of determining these parameters is implicitly realized with the acquisition itself and the information is merely identified as such; moreover, in this digital case, “acquisition system” refers to one or more processing units with any associated digital data acquisition peripherals.

Since the position of the glass pane in the furnace is known at every instant because the rollers are operated electronically, it is possible to always know where the glass pane is, instant by instant, and therefore also where its parts with different absorption are. Indeed, the acquisition of the image of the glass pane from the top then allows processing the image and identifying, automatically or by an operator, which zones have differentiated absorption, to then be able to follow them inside the furnace.

For clarity, and by way of example, FIG. 1 (c) shows three zones in the exemplary glass pane: the zone of a screen-printed edge 21, the zone of a window 22 and the rest of the glass pane 23.

More heat can be supplied to the non-screen-printed part (but this applies to any part that absorbs less) both by radiation and by forced convection, directing jets of hot air towards it which, for obvious reasons, must not also affect the screen-printed areas, by activating or deactivating (including partial or fractional activation/deactivation) the electric heating elements corresponding to these zones.

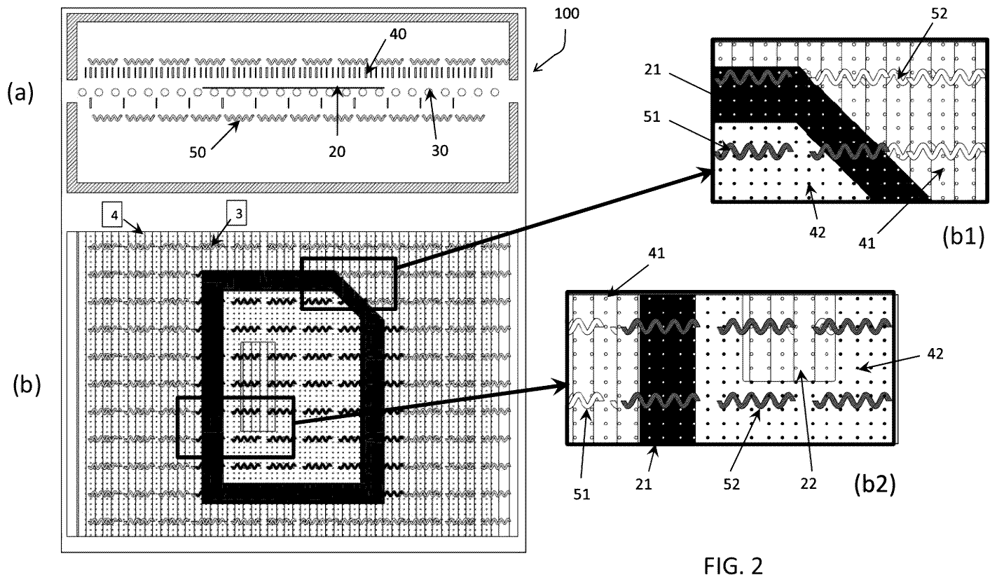

Referring also to FIG. 2 (a), in addition to the conveyor rollers 30, an array of (preferably infrared) resistances 50 and an array of nozzles 40 are arranged in furnace 100.

FIG. 2 (b) shows, in plan, the glass pane 20 with the resistances and nozzles (at times they appear as balls) superimposed. Generally, the resistances 52 or the black solid balls 42 are activated, while the resistances 51 and the white empty balls 41 are deactivated. However, it is also possible to adjust the resistances with an intermediate activation, and the same is valid for the nozzles. Hereinafter reference is only made to the case of complete activation/deactivation for descriptive simplicity.

According to the present invention, as shown in the details of FIGS. 2 (b1) and (b2), the hot air is blown by the individual nozzles activated at the zones of the glass pane not screen-printed, while they are not activated outside these zones.

The same concept applies to the window of the glass pane, even if this is not shown in the figures.

The nozzles and/or the resistances are activated or deactivated in proportion to the zone type which progressively falls within a considered zone.

The system according to the present invention is particularly advantageous in the case of automobile glass panes, or low-emissivity glass panes, as they present screen-printed zones (edges).

Preferred embodiments have been described above and variations of the present invention have been suggested, but it should be understood that those skilled in the art may make modifications and changes without departing from the related scope of protection, as defined by the appended claims.

1. A method for tempering glass panes, comprising performing the following steps:
(a) acquiring an image of a glass pane conveyed on conveyor rollers;
(b) acquiring a distribution map of heat absorption coefficient in the glass pane conveyed on conveyor rollers;
(c) recognizing, by an electronic processing unit, a geometric shape and the overall dimensions of the glass pane based on the image acquired in step (a);
(d) recognizing, by the electronic processing unit, based on the distribution map of heat absorption coefficient of step (b), a position of one or more parts with respective heat absorption coefficient within the geometric shape of step (c);
(e) conveying the glass pane on the conveyor rollers into a tempering furnace provided with an array of resistances and an array of nozzles;
(f) determining, by an electronic processing unit, an instantaneous position of the glass pane and of the one or more parts with respective heat absorption coefficient, inside the tempering furnace; and
(g) individually activating the resistances of the array of resistances and the nozzles of the array of nozzles as a function of their proximity to the one or more parts with respective heat absorption coefficient, and in inversely proportional manner to the respective heat absorption coefficient.

2. The method of claim 1, wherein the distribution map of heat absorption coefficient of step (b) is not used in step (c).

3. The method of claim 1, wherein the glass pane is a low-emissivity glass pane.

4. The method of claim 1, wherein the glass pane is a glass pane with a screen-printed edge.

5. A furnace for tempering glass panes, comprising:
an image acquisition system for acquiring images, configured to acquire an image of a glass pane conveyed on conveyor rollers;
a system for acquiring a distribution map of heat absorption coefficient of the glass pane conveyed on conveyor rollers;
a first electronic processing unit configured to recognize, in said image, a geometric shape and overall dimensions of the glass pane based on an output of the image acquisition system, and to recognize shape and dimensions of one or more parts with respective heat absorption coefficient within said image based on an output of the system for acquiring the distribution map of heat absorption coefficient and on the geometric shape and the overall dimensions of the glass pane;
an array of resistances and an array of nozzles inside the furnace;
a second electronic processing unit configured to determine an instantaneous position of the glass pane and of the one or more parts with respective heat absorption coefficient inside the furnace; and
a third electronic processing unit configured to individually activate the resistances of the array of resistances and the nozzles of the array of nozzles as a function of their proximity to the one or more parts with respective heat absorption coefficient, and in an inversely proportional manner to the respective heat absorption coefficient.

6. The furnace of claim 5, wherein the first electronic processing unit is not configured to use the distribution map of heat absorption coefficient to recognize the geometric shape and the overall dimensions of the glass pane.

7. The furnace of claim 5, wherein the second and third electronic processing units are a single electronic processing unit.

8. The furnace of claim 5, wherein the second and third electronic processing units are configured to temper a low-emissivity glass pane.

9. The furnace of claim 5, wherein the second and third electronic processing units are configured to temper a glass pane with a screen-printed edge.
